(19) United States
(12) Patent Application Publication
(10) Pub. No.: US 2014/0121871 A1
(43) Pub. Date: May 1, 2014

(54) METHOD AND SYSTEM FOR CONTROLLING THE CHARGING OF A HYBRID VEHICLE

(71) Applicants: HYUNDAI MOTOR COMPANY, Seoul (KR); KIA MOTORS CORPORATION, Seoul (KR)

(72) Inventor: Sang Joon Kim, Seoul (KR)

(73) Assignees: KIA MOTORS CORPORATION, Seoul (KR); HYUNDAI MOTOR COMPANY, Seoul (KR)

(21) Appl. No.: 13/711,314

(22) Filed: Dec. 11, 2012

(30) Foreign Application Priority Data
Oct. 31, 2012 (KR) 10-2012-0121976

(51) Int. Cl. B60W 20/00; B60W 10/08; B60W 10/26; B60W 10/06

(52) U.S. Cl. CPC B60W 20/00; B60W 10/06; B60W 10/08; B60W 10/26; Y10S 903/93; B60W 2510/244
USPC 701/22; 180/65.28; 180/65.265; 903/930

(57) ABSTRACT

Disclosed is a method and a system for controlling charging of a hybrid vehicle which controls engine idle by using a starting/generating motor when a battery is charged. The method includes: determining a target charging to be charged in the battery by the starting/generating motor and a target torque of the starting/generating motor for generating the target charging amount based on a state of charge (SOC) of the battery and power consumption of a load of an electric device when the engine is idle; driving the engine by applying a command of torque corresponding to the target torque to the engine; detecting torque actually output from the starting/generating motor; calculating an error between the actual torque and the target torque; calculating an engine torque compensation value based on the calculated error; and feedback controlling an idle speed of the engine by adding the engine torque compensation value to the command of torque of the engine.

### CROSS-REFERENCE TO RELATED APPLICATION

This application claims priority to and the benefit of Korean Patent Application No. 10-2012-0121976 filed in the Korean Intellectual Property Office on Oct. 31, 2012, the entire contents of which are incorporated herein by reference.

### BACKGROUND OF THE INVENTION

(a) Field of the Invention

The present invention relates to a method and a system for controlling the charging of a hybrid vehicle, particularly a method and system which controls engine idle through feedback control of a starting/generating motor when a battery is charged using the starting/generating motor.

(b) Description of the Related Art

Hybrid vehicles operate through the use of power from an internal combustion engine and power from a battery. In particular, hybrid vehicles are designed to efficiently combine and use power of the internal combustion engine and the motor.

For example, as illustrated in FIG. 1, a hybrid vehicle includes: an engine 10; a motor 20; an engine clutch 30 for cutting off power between the engine 10 and the motor 20; a transmission 40; a differential gear apparatus 50; a battery 60; a starting/generating motor 70 for starting the engine 10 or generating power by output of the engine 10; and wheels 80.

As further shown, the hybrid vehicle includes a hybrid control unit (HCU) 200 for controlling the general operation of the hybrid vehicle, a battery control unit (BCU) 120 for managing and controlling the battery 60, a motor control unit (MCU) 130 for controlling the operation of the motor 20, and an engine control unit (ECU) 140 for controlling an operation of the engine 10. The battery control unit 120 may also be referred to as a battery management system (BMS).

Constituent elements of the hybrid vehicle are known to those skilled in the art, so that more detailed disclosures will be omitted.

In the vehicle industry, the starting/generating motor 70 may also be referred to as an integrated starter & generator or a hybrid starter & generator (HSG).

The hybrid vehicle may run in a driving mode, such as a pure electric vehicle (EV) mode using only power of the motor 20, a hybrid electric vehicle (HEV) mode using torque of the engine 10 as a main power and torque of the motor 20 as an auxiliary power, and a regenerative braking (RB) mode during braking or when the vehicle runs by inertia. In the RB mode, braking and inertia energy are collected through power generation of the motor 20, and the battery 60 is charged with the collected energy.

As such, the hybrid vehicle uses mechanical energy of the engine and electric energy of the battery together, uses an optimal operation region of the engine and the motor, and collects energy with the motor when the vehicle brakes, so that it is possible to improve fuel efficiency and more efficiently utilize energy.

Further, in an engine idle state, the hybrid vehicle can further charge the battery 60 through power generation of the starting/generating motor 70 depending upon a state of charge (SOC) of the battery 60.

However, in such conventional hybrid vehicles, engine idle is controlled by the engine when the battery is charged by driving the starting/generating motor as a power generator. Thus, there is a problem in that fuel efficiency deteriorates and power generated by the starting/generating motor for charging the battery is inaccurate.

In particular, when engine idle is controlled in such conventional designs through feedback control of the engine itself, the engine is generally controlled by opening a throttle valve wide and retarding an ignition timing in order to stably control a speed against charging torque variation of the motor and the like. As a result, a large amount of fuel is unnecessarily consumed.

Further, when the engine idle is controlled in such conventional designs through the feedback control of the engine itself, friction of the engine varies based on a temperature of coolant and other variables. As a result, torque control accuracy deteriorates, and charging power by the power generation of the starting/generating motor may be inaccurate.

Accordingly, when a target amount of charging is determined, and the torque to be output by the engine is determined in the engine idle state based on this target amount, the engine frequently fails to output the required torque. In this case, a problem occurs in that the starting/generating motor charges an amount less than the target charging amount. For example, when the hybrid vehicle is in a state where an electric device excessively uses loads for a long period of time, such as when an air conditioner is turned on and lamps are turned on while the hybrid vehicle is stopped, the SOC of the battery may be depleted.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a method and a system for controlling the charging of a hybrid vehicle that improves a function of balancing an SOC of a battery and improving battery charging control accuracy. In particular, according to the present method and system, engine idle control is performed through feedback control of a starting/generating motor when the battery is charged using the starting/generating motor in the hybrid vehicle.

According to one aspect, the present invention provides a method for controlling the charging of a hybrid vehicle that includes a starting/generating motor configured to start an engine or charge a battery by generating power by torque of the engine, the method including: determining a target charging amount to be charged in the battery by the starting/generating motor, and a target torque of the starting/generating motor for generating the target charging amount based on a state of charge (SOC) of the battery and power consumption of a load of one more electric devices of the vehicle when the engine is idle; driving the engine by commanding an engine torque in an amount corresponding to the target torque of the motor through a feedforward control function; detecting torque actually output from the starting/generating motor based on rotation by the driving of the engine; calculating an error between the actual torque of the motor and the target torque of the motor by feeding back the detected actual torque of the motor; calculating an engine torque compensation value based on the calculated error; and controlling an idle speed of the engine by a feedback control function by adding the engine torque compensation value to the torque commanded of the engine.

According to various embodiments, the method of controlling the charging further includes monitoring the error between the actual torque of the motor and the target torque of the motor for a predetermined time, and accumulating the total amount of the monitored error for the predetermined time.

According to various embodiments, when an accumulated error value of the torque of the motor is equal to or larger than a predetermined value, the calculating of the error and subsequent steps are sequentially repeated. Further, when the accumulated error value of the torque of the motor is smaller than the predetermined value, the calculating of the engine torque compensation value and subsequent steps are not performed.

According to various embodiments, the accumulated error value of the torque is divided into units or groups of a predetermined size, and feedback compensation for the driving torque of the engine is carried out in a stepwise manner for each unit or group.

According to various embodiments, the method of controlling the charging further includes: first determining whether the engine is in an idle stable state based on the idle speed of the engine; and when it is determined that the engine is in the idle stable state, then determining the target charging amount.

According to another aspect, the present invention provides a system for controlling the charging of a hybrid vehicle including a starting/generating motor configured to start an engine or charge a battery by generating power by torque of the engine, the system including: a battery control unit configured to control and manage the battery; an engine control unit configured to control the engine; and a hybrid control unit configured to control the starting/generating motor and the hybrid vehicle, wherein the hybrid control unit is operated by a predetermined program. The predetermined program includes a series of commands stored on a computer readable medium and executed by a controller for performing the method of controlling the charging of the hybrid vehicle.

According to various embodiments, the hybrid control unit may include: a target charging amount determination unit configured to determine a target charging amount to be charged in the battery by the starting/generating motor, and a target torque of the starting/generating motor for generating the target charging amount based on a state of charge (SOC) of the battery and power consumption of a load of one or more electric devices of the hybrid vehicle; an engine driving unit configured to drive the engine by applying a torque to the engine corresponding to the target torque of the motor to the engine through feedforward; a motor torque detection unit configured to detect torque actually output from the starting/generating motor as rotated by the driving of the engine; a motor torque error calculation unit configured to calculate an error between the actual torque of the motor and the target torque of the motor by feeding back the actual torque of the motor detected by the motor torque detection unit; and an engine torque compensation value calculation unit configured to calculate an engine torque compensation value based on the calculated error so that driving torque of the engine is compensated for; and wherein the engine driving unit is configured to receive the engine torque compensation value through feedback, and combine the compensation value with the torque applied to the engine to thereby provide feedback control at an idle speed of the engine.

According to various embodiments, the hybrid control unit may further include an engine idle state determination unit configured to determine whether the engine is in an idle stable state based on an idle speed of the engine.

As described above, the present invention improves a function of balancing an SOC of a battery and improves battery charging control accuracy by controlling engine idle through feedback control and use of the starting/generating motor when the battery of the hybrid vehicle is charged.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram conceptually illustrating a configuration of a conventional hybrid vehicle.

FIG. 2 is a configuration diagram of a charging control system for a hybrid vehicle which uses feedback control of a starting/generating motor according to an exemplary embodiment of the present invention.

FIG. 3 is a flowchart of a charging control method for a hybrid vehicle which uses feedback control of a starting/generating motor according to an exemplary embodiment of the present invention.

FIGS. 4 to 7 are graphs which depict an operation of a charging control method and system for a hybrid vehicle which uses feedback control of a starting/generating motor according to an exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE EMBODIMENTS

Hereinafter, the present invention will be described more fully with reference to the accompanying drawings, in which exemplary embodiments of the invention are shown. As those skilled in the art would realize, the described embodiments may be modified in various different ways, all without departing from the spirit or scope of the present invention.

In the specification, unless explicitly described to the contrary, the word “comprise” and variations such as “comprises” or “comprising”, will be understood to imply the inclusion of stated elements but not the exclusion of any other elements.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Additionally, it is understood that the below methods are executed by at least one controller. The term controller refers to a hardware device that includes a memory and a processor. The memory is configured to store the modules and the processor is specifically configured to execute said modules to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

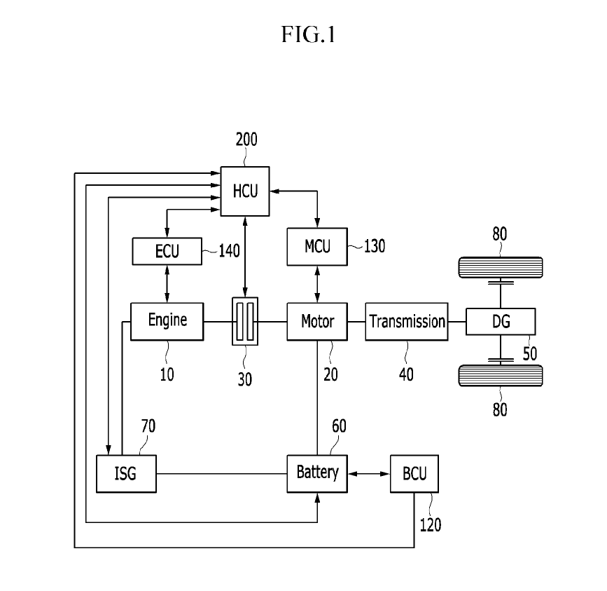

FIG. 1 is a diagram schematically illustrating a hybrid vehicle to which a charging control system according to an exemplary embodiment of the present invention may be applied.

As illustrated in FIG. 1, a hybrid vehicle to which a charging control system according to an exemplary embodiment of the present invention can be applied generally includes: an engine 10, a motor 20, an engine clutch 30 for cutting off power between the engine 10 and the motor 20; a transmission 40; a differential gear apparatus 50; a battery 60; a starting/generating motor 70 for starting the engine 10 or generating power by output of the engine 10; wheels 80; a hybrid control unit 200 for controlling the overall operation of the hybrid vehicle; a battery control unit 120 for managing and controlling the battery 60; a motor control unit 130 for controlling operation of the motor 20; and an engine control unit 140 for controlling operation of the engine 10.

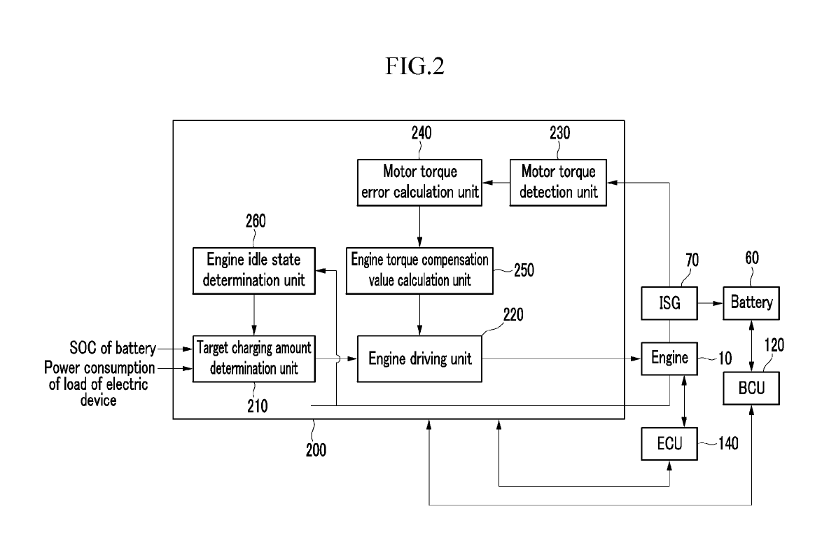

FIG. 2 is a block diagram schematically illustrating a charging control system for a hybrid vehicle according to an exemplary embodiment of the present invention.

The charging control system according to the exemplary embodiment of the present invention is a charging control system configured for controlling an engine 10 idle speed through feedback control of the starting/generating motor 70 when the battery 60 is charged through power generation of the starting/generating motor 70. By performing the control of the engine idle speed through the feedback control of the starting/generating motor 70, rather than through feedback control by the engine 10, provides numerous advantages.

Torque of the starting/generating motor 70 generally has a control accuracy higher than that of the engine 10. Further, in a case of the engine 10, mechanical friction is large, deviation by a temperature of coolant and other external factors is large, and response characteristics and the like are not good compared to that of the starting/generating motor 70. Thus, accuracy of output torque control using the engine 10 is low.

In the charging control system according to the present invention, the battery control unit 120 for controlling and managing the battery 60 and the engine control unit 140 for controlling the engine 10 naturally transmit and receive signals to/from each other. Further, the present charging control system includes a hybrid control unit 200 for controlling a general operation of the starting/generating motor 70 and the hybrid vehicle.

According to an exemplary embodiment, the hybrid control unit 200 is operated by a predetermined program, and the predetermined program includes a series of commands for performing a charging control method according to the present invention as further described below. The predetermined program may include a plurality of modules for performing a corresponding operation, and the plurality of program modules may be combined with hardware including, for example, a microprocessor, an IC, and an electronic component, to perform an operation.

According to an exemplary embodiment, the hybrid control unit 200 is formed as a proportional integral (PI) control unit or a proportional integral derivative (PID) control unit configured for performing feedfoward control and/or feedback control in order to perform a charging control method as further described below.

Some processes in a charging control method according to an exemplary embodiment of the present invention may be performed by the battery control unit 120, and other processes may be performed by the engine control unit 140. An example of processes that may be performed by the battery control unit 120 and which may be performed by the engine control unit 140 is further described below. However, it should not be understood that the scope of the present invention is not limited to an exemplary embodiment to be described below. The hybrid control unit 200 may be implemented with a different combination than that described in the exemplary embodiment of the present invention. Further, the battery control unit 120 and the engine control unit 140 may perform a different combination of processes than those described in the exemplary embodiment.

According to an exemplary embodiment, the hybrid control unit 200 includes a target charging amount determination unit 210 configured for determining a target charging amount to be charged in the battery 60 by the starting/generating motor 70, and a target torque of the starting/generating motor 70 for generating the target charging amount. These determinations are made based on a state of charge (SOC) of the battery 60 and power consumption of a load of one or more electric devices of the hybrid vehicle.

The target charging amount determination unit 210 may include a combination of program instructions and hardware for carrying out the determination of target charging amount and target torque. However, but it should be understood that the scope of the present invention is not limited to this combination. Rather, the technical spirit of the present invention will also apply to various other configurations that enables a determination of a substantial target charging amount and target torque corresponding to the target charging amount.

As shown in FIG. 2, the hybrid control unit 200 includes an engine driving unit 220, which is configured for applying a torque command to the engine 10 that corresponds to the determined target torque, and driving the engine 10.

The target charging amount determination unit 210 may transmit the target torque of the starting/generating motor 70 to the engine driving unit 220 through a feedforward command so that the engine driving unit 220 may apply the command of the engine torque corresponding to the target torque to the engine 10.

The engine driving unit 220 may include a combination of program instructions and hardware for receiving the target torque transmitted by the target charging amount determination unit 210 and for applying the command of torque to the engine 10. However, it should be understood that the scope of the present invention is not limited to this combination. Rather, the technical spirit of the present invention will be applied to various other configurations capable of commanding the torque of the engine to the engine 10 through a feedfoward command, and driving the engine 10.

As shown in FIG. 2, the hybrid control unit 200 may further include a motor torque detection unit 230 configured for detecting actual torque of the starting/generating motor 70. The actual torque of the starting/generating motor 70 is the torque actually output from the starting/generating motor 70 which is rotated by driving of the engine 10.

The motor torque detection unit 230 may be formed as a combination of program instructions and hardware. However, it should be understood that the scope of the present invention not is limited to this combination. Rather, the technical spirit of the present invention will be applied to various other configurations capable of detecting torque actually output from the starting/generating motor 70.

As further shown in FIG. 2, the hybrid control unit 200 may include a motor torque error calculation unit 240 configured for calculating an error in the target torque of the starting/generating motor 70 by feeding back the actual torque of the starting/generating motor 70 as detected by the motor torque detection unit 230.

According to an exemplary embodiment, the motor torque error calculation unit 240 is configured to integrate the error for a predetermined time, and accumulate the integrated error similar to an integrator of the proportional integral (P1) control unit. In particular, the motor torque error calculation unit 240 may be configured to feed back the actual torque of the starting/generating motor 70 and accumulate a total value of the difference between the feedback torque of the starting/generating motor 70 and the target torque of the starting/generating motor 70 as an integral term (I-term) for a predetermined time.

The motor torque error calculation unit 240 may be formed as a combination of program instructions and hardware. However, it should be understood that the scope of the present invention is not limited thereto. Rather, the technical spirit of the present invention will applied to various other configurations capable of substantially calculating an engine torque compensation value for compensating driving torque of the engine.

As shown in FIG. 2, the hybrid control unit 200 may further include an engine torque compensation value calculation unit 250 configured for calculating an engine torque compensation value. As such, driving torque of the engine is compensated for based on an error value of the torque of the motor as calculated by the motor torque error calculation unit 240.

The engine torque compensation value calculation unit 250 may include a combination of instructions program and hardware. However, but it should be understood that the scope of the present invention is not limited thereto. Rather, the technical spirit of the present invention will apply to various other configurations capable of substantially calculating an engine torque compensation value for compensating driving torque of the engine.

According to an exemplary embodiment, when the compensation value calculated by the engine torque compensation value calculation unit 250 is input, the engine driving unit 220 may be configured to feedback control an idle speed of the engine 10 by combining the compensation value with the command of the engine torque.

The hybrid control unit 200 may include an engine idle state determination unit 260 configured for determining whether the engine 10 is in an idle stable state based on the idle speed of the engine 10.

The engine idle state determination unit 260 may be formed to include program instructions and hardware. However, it should be understood that the scope of the present invention is not limited thereto. Rather, the technical spirit of the present invention will also applied to various other configurations capable of substantially determining whether the engine is in the idle stable state.

The target charging amount determination unit 210 and the engine driving unit 220 may be configured to perform their corresponding operations when the engine idle state determination unit 260 determines that the idle state of the engine 10 is stable.

Hereinafter, a charging control method for a hybrid vehicle according to an exemplary embodiment of the present invention will be described in detail with reference to the accompanying drawings.

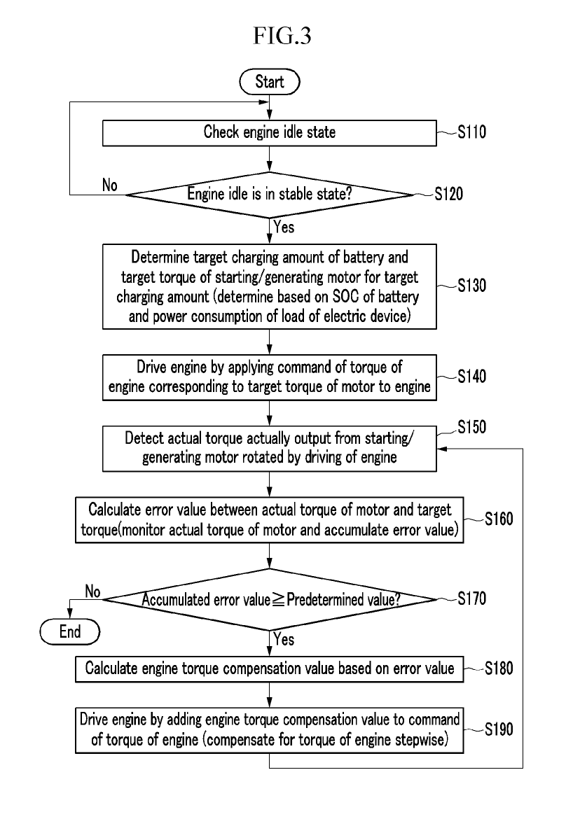

FIG. 3 is a flowchart illustrating a battery charging control method for a hybrid vehicle according to an exemplary embodiment of the present invention.

As illustrated in FIG. 3, the engine idle state determination unit 260 of the hybrid control unit 200 determines whether the engine is in an idle stable state based on an idle speed of the engine 10 (S110 and S120). For example, when the idle speed is maintained as 800 to 1,000 RPM for a predetermined time, the engine idle state determination unit 260 may determine that the engine is in an idle stable state.

When it is determined that the engine 10 is not in the idle stable state, the target charging amount determination unit 210 of the hybrid control unit 200 do not perform their corresponding operations.

Thus, in the exemplary embodiment of the present invention shown in FIG. 3, the target charging amount determination unit 210 of the hybrid control unit 200 performs engine torque compensation control (as further described below) after the idle state of the engine 10 becomes stable. This is beneficial because performing engine torque compensation control may cause instability in the engine idle state if it is performed before the idle state of the engine 10 becomes stable.

When the engine idle state determination unit 260 determines that the idle state of the engine is stable, the target charging amount determination unit 210 of the hybrid control unit 200 determines (a) a target charging amount to be charged in the battery 60 by the starting/generating motor 70, and (b) a target torque of the starting/generating motor 70 for generating the target charging amount based on a state of charge (SOC) of the battery 60 and power consumption of a load of one or more electric devices (S130).

The target charging amount determination unit 210 is configured to transmits the target torque of the motor to the engine driving unit 220 through a feedforward term. When the target charging amount and the target torque of the motor are determined by the target charging amount determination unit 210, then the engine driving unit 220 of the hybrid control unit 200 drives the engine 10 by applying a command of torque of the engine corresponding to the target torque of the motor to the engine 10 (S140).

When the engine 10 is driven by the hybrid control unit's 200 command of torque in an amount corresponding to the target torque of the motor, the starting/generating motor 70, which is in connection with the engine 10, generates power to charge the battery 60.

The program instructions and hardware in connection with the engine 10 for providing the power generation by the starting/generating motor 70 can be in accordance with configurations known to one skilled in the art, so that a detailed description thereof will be omitted.

When the starting/generating motor 70 generates power with power of the engine 10 to charge the battery 60, the motor torque detection unit 230 of the hybrid control unit 200 detects the torque actually output from the starting/generating motor 70 based on rotation thereof by driving of the engine 10 (S150).

When the actual torque of the starting/generating motor 70 is detected by the motor torque detection unit 230, the motor torque error calculation unit 240 of the hybrid control unit 200 calculates an error between the detected actual torque of the starting/generating motor 70 and the target torque of the starting/generating motor 70 (S160).

According to the exemplary embodiment of the present invention, since an internal feedback control unit of the hybrid control unit 200 uses a value corresponding to the target torque of the starting/generating motor 70 as the feedforward term, the integral term (I-term) of the internal feedback control unit has a value close to 0 if an output value of the torque of the engine 10 corresponding to the actual torque of the starting/generating motor 70 is accurate. However, when the output value of the torque of the engine 10 is not accurate, a value equivalent to the error is accumulated in the integral term (I-term) of the internal feedback control unit.

The motor torque error calculation unit 240 monitors the actual torque of the motor, and accumulates an error value between the actual torque of the starting/generating motor 70 and the target torque of the starting/generating motor 70 for a predetermined time. The accumulation of the error value for the predetermined time may be performed through, for example, an integrator of the proportional integral (PI) feedback control unit. Of course, the accumulation of the error value may be performed by any variety of control units configurations that may be differ from that of the integrator of the proportional integral (PI) feedback control unit, but are capable of substantially accumulating the error value.

Once the error value has been accumulated by the motor torque error calculation unit 240 for the predetermined time, the engine torque compensation value calculation unit 250 of the hybrid control unit 200 determines whether the accumulated error value is equal to or larger than a predetermined value (S170). The predetermined value, which is compared with the accumulated error value, is a reference value for determining whether it is necessary to compensate for driving torque of the engine 10. Accordingly, the predetermined value is set to a value at which the driving torque of the engine 10 does not need to be compensated for.

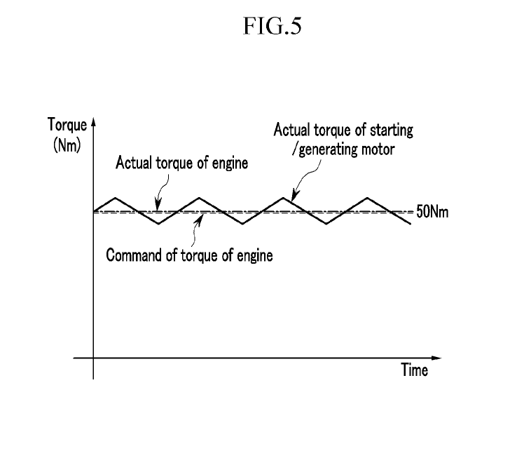

When it is determined that the accumulated error value is smaller than the predetermined value in the determination in step S170, then it is determined that the starting/generating motor 70 generates a torque necessary for generating the target charging amount by the driving torque of the engine 10 (see FIG. 5). As such, the motor torque error calculation unit 240 does not provide the engine torque compensation value calculation unit 250 with the accumulated error value.

On the other hand, if it is determined that the accumulated error value is equal to or larger than the predetermined value in the determination in step S170, then the motor torque error calculation unit 240 provides the accumulated error value to the engine torque compensation value calculation unit 250.

When an accumulated error value is provided to the engine torque compensation value calculation unit 250, the engine torque compensation value calculation unit 250 calculates an engine torque compensation value based on the provided error value so that the driving torque of the engine is compensated for (S180). The engine torque compensation value calculation unit 250 then feeds back the engine torque compensation value to the engine driving unit 220.

The engine driving unit 220 then performs feedback control while compensating for the engine 10 by adding the engine torque compensation value to the command of the engine torque received in step S140 (S190).

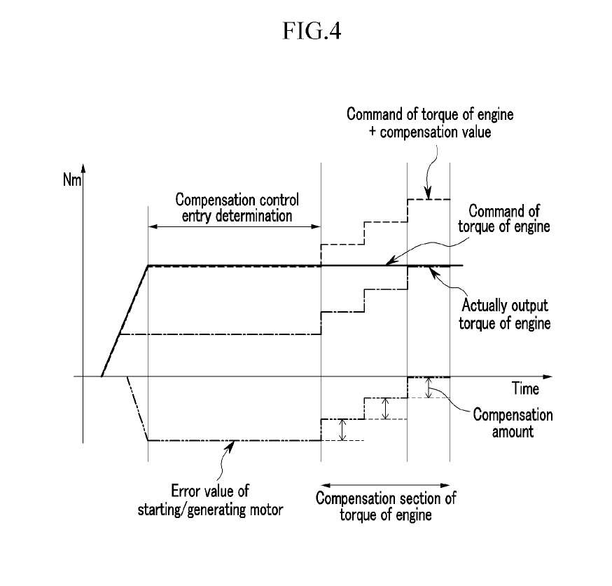

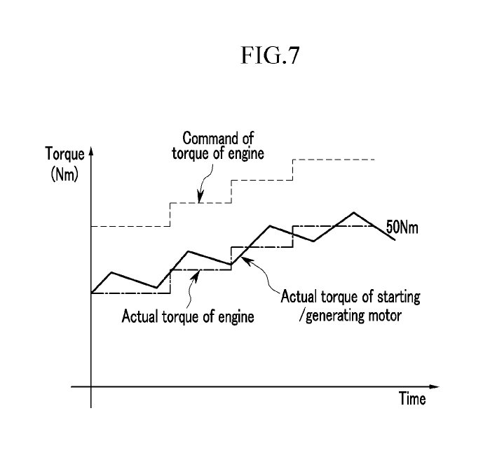

When the engine driving unit 220 drives the engine 10 through the feedback control by adding the engine torque compensation value to the command of the engine torque, the torque of the engine 10 may be considerably changed. Accordingly, in order to prevent the torque of the engine 10 from being considerably changed, the engine driving unit 220 may compensate for the torque of the engine in a stepwise manner. For example, the engine torque compensation value may be divided into a plurality of units or groups of a predetermined size, such as shown in the exemplary embodiment of the present invention as illustrated in FIGS. 4 and 7 (S190).

As illustrated in FIG. 4, when engine driving unit 220 compensates for the torque of the engine 10 stepwise by dividing the engine torque compensation value into units of predetermined size, the torque of the starting/generating motor 70 is changed stepwise, and the actual torque of the starting/generating motor 70 may be adjusted to the target torque to generate the desired target charging amount.

In particular, by sequentially and repeatedly performing steps S150 to S190 until the error value of the torque of the motor becomes smaller than the predetermine value, it is possible to feedback control the actual torque of the starting/generating motor 70 to be the target torque of the motor so that the starting/generating motor 70 generates the desired target charging amount in the idle state of the engine 10.

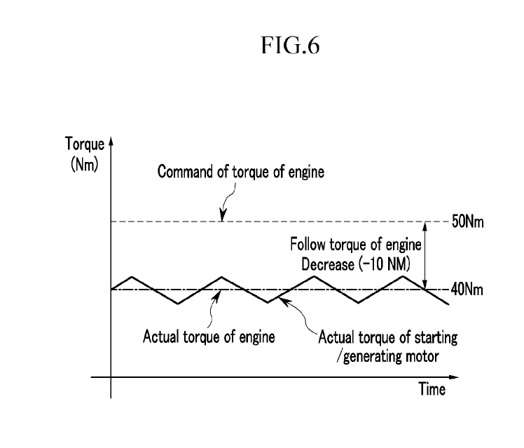

FIGS. 5 to 7 are graphs describing the exemplary embodiment of the present invention for three cases: (1) the actual torque follows the torque of the engine (FIG. 5), (2) the actual torque outputs a value smaller than the target torque of the engine (FIG. 6), and (3) the actual torque outputs a value smaller than the target torque of the engine and driving of the engine is controlled stepwise (FIG. 7).

In order to describe FIGS. 5 to 7, it is assumed in the exemplary embodiment of the present invention that the target torque of the starting/generating motor 70 is 50 Nm, and the command of the torque of the engine corresponding to the target torque is also 50 Nm. Further, a pulley ratio between the engine 10 and the starting/generating motor 70 is assumed to be 1 for convenience of the description.

FIG. 5 illustrates a case in which the actual torque follows the torque of the engine. That is, the case of FIG. 5 is an example of a case in which the accumulated error value used as the aforementioned feedback control value is approximately 0.

FIG. 6 illustrates a case in which the actual torque outputs a value 40 Nm smaller than the command value 50 Nm of the torque of the engine. In this case, the accumulated error value used as the feedback control value is −10 Nm, and the error value is a value by which the torque of the engine is to be compensated for.

FIG. 7 illustrates a case in which the driving of the engine is controlled stepwise by adding the compensation value to the command of the torque of the engine in order to compensate for the error value of FIG. 6. That is, through the stepwise compensation of the torque of the engine, the error value −10 Nm of FIG. 6 becomes 0.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

<Description of symbols>

| | |
|---|---|
| 10: Engine | 20: Motor |
| 30: Engine clutch | 40: Transmission |
| 50: Differential gear apparatus | 60: Battery |
| 70: Starting/generating motor | 80: Wheels |
| 120: Battery control unit | 130: Motor control unit |
| 140: Engine control unit | 200: Hybrid control unit |
| 210: Target charging amount | |
| determination unit | |
| 220: Engine driving unit | 230: Motor torque detection |
| | unit |
| 240: Motor torque error calculation unit | |
| 250: Engine torque compensation value | |
| calculation unit | |
| 260: Engine idle state determination unit | |

1. A method for controlling charging of a hybrid vehicle executed by a processor within a controller, the hybrid vehicle comprising a starting/generating motor configured to start an engine or charge a battery by generating power by torque of the engine, the method comprising:
(i) determining a target charging to be charged in the battery by the starting/generating motor, and a target torque of the starting/generating motor for generating the target charging amount based on a state of charge (SOC) of the battery and power consumption of a load of an electric device when the engine is idle;
(ii) driving the engine by applying a torque command corresponding to the target torque of the motor to the engine through a feedforward control function;
(iii) detecting actual torque output from the starting/generating motor as rotated by driving of the engine;
(iv) calculating an error between the actual torque and the target torque by feeding back the detected actual torque of the motor;
(v) calculating an engine torque compensation value based on a value of the calculated error;
(vi) controlling an idle speed of the engine by feedback adding the engine torque compensation value to the torque command applied to the engine; and
(vii) monitoring the error between the actual torque and the target torque for a predetermined time and accumulating the monitored error to provide an accumulated monitored torque error,
wherein the accumulated monitored torque error is divided into a plurality of units of a predetermined size, and wherein feedback adding the engine torque compensation value is carried out stepwise.

2. (canceled)

3. The method of claim 1, wherein:
when the accumulated monitored torque error is equal to or larger than a predetermined value, steps (v) to (vi) are sequentially repeated, and when the accumulated monitored torque error is smaller than the predetermined value, steps (v) to (vi) are not performed.

4. (canceled)

5. The method of claim 1, further comprising:
prior to step (i) determining whether the engine is in an idle stable state based on the idle speed of the engine; and
when the engine is in the idle stable state, proceeding to step (i).

6. A system for controlling charging of a hybrid vehicle, the hybrid vehicle comprising a starting/generating motor configured to start an engine or charge a battery by generating power by torque of the engine, the system comprising:
a battery control unit configured to control and manage the battery;
an engine control unit configured to control the engine; and
a hybrid control unit configured to control the starting/generating motor and the hybrid vehicle,
wherein the hybrid control unit is operated by a predetermined program, and the predetermined program includes a series of commands for performing the method of claim 1.

7. The system of claim 6, wherein:
the hybrid control unit comprises:
a target charging amount determination unit configured to determine a target charging to be charged in the battery by the starting/generating motor, and a target torque of the starting/generating motor for generating the target charging amount based on a state of charge (SOC) of the battery and power consumption of a load of an electric device;
an engine driving unit configured to drive the engine by applying a command of the torque of the engine corresponding to the target torque of the motor to the engine through a feedforward control function;
a motor torque detection unit configured to detect torque actually output from the starting/generating motor rotated by the driving of the engine;
a motor torque error calculation unit configured to calculate an error between the actual torque of the motor and the target torque of the motor by feeding back the actual torque of the motor detected by the motor torque detection unit; and
an engine torque compensation value calculation unit configured to calculate an engine torque compensation value based on the error of the torque calculated; and
wherein the engine driving unit is configured to receive the engine torque compensation value and combine the engine torque compensation value with the command of the torque to feedback control an idle speed of the engine.

8. The system of claim 6, wherein:
the hybrid control unit further comprises:
an engine idle state determination unit configured to determine whether the engine is in an idle stable state based on an idle speed of the engine.

9. A non-transitory computer readable medium containing program instructions executed by a processor for controlling charging of a hybrid vehicle, the computer readable medium comprising:
program instructions that determine a target charging and a target torque value based on a state of charge (SOC) of a battery and power consumption of a load of an electric device when the hybrid vehicle engine is idle;
program instructions that drive the engine by applying a torque command corresponding to the target torque of the motor to the engine through a feedforward control function;
program instructions that detect actual torque output from the starting/generating motor;
program instructions that calculate an error between the actual torque and target torque;
program instructions that calculate an engine torque compensation value based on a value of the calculated error;
program instructions that control an idle speed of the engine by feedback adding the engine torque compensation value to the torque command applied to the engine; and
program instructions that monitor the error between the actual torque and the target torque for a predetermined time and accumulating the monitored error to provide an accumulated monitored torque error,
wherein the accumulated monitored torque error is divided into a plurality of units of a predetermined size, and wherein feedback adding the engine torque compensation value is carried out stepwise.
